(19) United States
(12) Patent Application Publication
(10) Pub. No.: US 2014/0026480 A1
(43) Pub. Date: Jan. 30, 2014

(54) STORMWATER RUNOFF CONTROL FOR VEGETATIVE-AND NON-VEGETATIVE-BASED ROOFING SYSTEMS

(71) Applicant: CGT, Inc., Portland, OR (US)

(72) Inventors: James H. Lenhart, JR., Portland, OR (US); Timothy J. Nash, Mountain View, CA (US)

(21) Appl. No.: 13/869,630

(22) Filed: Apr. 24, 2013

Related U.S. Application Data
(60) Provisional application No. 61/638,273, filed on Apr. 25, 2012.

(51) Int. Cl. A01G 9/24

(52) U.S. Cl. CPC A01G 9/247
USPC 47/65.9

(57) ABSTRACT

A water collection tray for vegetative and non-vegetative rooftop systems includes sidewalls, a bottom, and an open top that defines an interior region. A water separation barrier located in the interior region between the bottom and the top has multiple openings through which water admitted to the tray enters a water collector. A drain opening out of the tray from the water collector and in fluid communication with a water flow regulator causes all of the water flowing out of the drain to pass through the water flow regulator. Multiple water collection trays configured in an interlocking system provide for attenuation of rainfall to reduce peak flows of stormwater runoff from rooftops.

### RELATED APPLICATION

This application claims the benefit of U.S. Provisional Application No. 61/638,273, filed Apr. 25, 2012, for METHOD OF AND APPARATUS FOR PROVIDING DISTRIBUTED DETENTION OF STORMWATER RUNOFF FROM ROOF TOPS USING VEGETATIVE-AND NON-VEGETATIVE-BASED TECHNIQUES, which is hereby incorporated by reference.

### TECHNICAL FIELD

This disclosure relates to vegetative eco-systems in the field of vegetative roof and vertical plane coverings and similar non-vegetated roof and coverings. In particular, an interlocking tray system, in either a vegetated or non-vegetated configuration, provides for the attenuation of rainfall to reduce peak flows of stormwater runoff from rooftops.

### BACKGROUND

In urban areas, rooftops take a large fraction of the total area that intercepts rainfall. Since rooftops typically are sloped, relatively smooth, impervious surfaces, rainfall collects quickly and develops into sheet flows to valleys and gutters where water accumulates. This accumulated water is discharged by gutters and roof drains to streets and surfaces below or directly to catch basins and subsurface pipes which convey stormwater runoff from the entire site to receiving waters.

Managing stormwater runoff this way can greatly increase the magnitude of the peak water flow into the receiving waters. Sudden flow increases can lead to accelerated bank erosion, natural habitat destruction, and localized flash flooding in natural water systems, and can introduce pollutants (e.g., trash, suspended solids, hydrocarbons, dissolved metals, and other hazardous compounds) originating from urban areas. Communities with combined storm and sanitary sewers may be unable to manage the sudden stormwater input, potentially leading to discharges of raw sewage to surface waters.

To combat this problem, the National Pollutant Discharge Elimination System (NPDES) was established to require communities in the United States to implement stormwater control measures that reduce pollutant loads prior to discharge into receiving waters. Under the NPDES, runoff from rooftops, parking lots, and streets is directed to structural control measures such as ponds, swales, sand filters, or other facilities where presumed levels of pollutants are removed by various physical and biological processes.

Concurrently, research on green roofs, also known as ecoroofs or vegetated roofs, began to emerge. Such research focuses on the heat island effect, building heat load reduction, aesthetic value, and to some extent, stormwater management using evapotranspirative losses and peak flow attenuation (2006 Stormwater Management Facility Monitoring Report, Bureau of Environmental Services, City of Portland, 2006). However, green roofs were not generally recognized as part of the mainstream regulatory and codified process. In 2009, the National Research Council reported that water runoff volume and rate control is as important as water quality, and that the use of distributed rate and volume management techniques, such as infiltration, rainwater harvesting, pervious paving systems, and green roofs may affect water quality. The Low Impact Development (LID) approach to managing stormwater has become the prevalent method of regulating stormwater management. Unfortunately, while green roofs can be effective at both retaining and detaining rainfall, existing green roof systems are unable to satisfy regulatory design requirements.

### BRIEF DESCRIPTION OF THE DRAWINGS

FIG. 1 is a top perspective view showing an embodiment of a water collection tray having an array of ribs of different sizes in a bottom interior surface.

FIG. 2 is a top plan view showing the water collection tray shown in FIG. 1.

FIG. 3 is a sectional view taken along line 3-3 of FIG. 2.

FIG. 4 is a sectional view showing a sloped bottom interior surface applicable to all embodiments of a water collection tray.

FIG. 5 is a top plan view showing an embodiment of a water collection tray having an array of water permeable wicks for transporting water upward from a water collector below a water separation barrier to a growing medium region above the water separation barrier.

FIG. 6 is a sectional view taken along line 6-6 of FIG. 5.

FIG. 7 is a top plan view showing an embodiment of a water collection tray having an absorbent medium compartment centrally positioned within a water collector, the water collector having bottom interior surfaces sloping toward a centrally located drain.

FIG. 8 is a sectional view taken along line 8-8 of FIG. 7.

FIG. 9 is an enlarged fragmentary view of the embodiment of the water collection tray shown in FIG. 3 showing a water flow regulator positioned at a bottommost location in a water collector.

FIG. 10 is a top plan view showing an embodiment of a water collection tray having a water flow regulator including a user-selectable restrictive orifice.

FIG. 11 is a sectional view taken along line 11-11 of FIG. 10.

FIG. 12 is a top plan view showing an array of concentrically arranged broken circular water channels formed in a bottom interior surface of an embodiment of a water collection tray.

FIG. 13 is a sectional view taken along line 14-14 of FIG. 13.

FIG. 14 is a top plan view showing an array of concentrically arranged broken diamond water channels formed in a bottom interior surface of an embodiment of a water collection tray.

FIG. 15 is a top plan view showing an embodiment of an array of water collection trays sharing a common drain pipe regulated by a common water flow regulator.

FIG. 16 is a sectional view taken along line 16-16 of FIG. 15.

FIG. 17 is a pictorial view of an embodiment of an irrigation water supply fluidly coupled with a drain pipe and a water flow regulator.

### DETAILED DESCRIPTION OF PREFERRED EMBODIMENTS

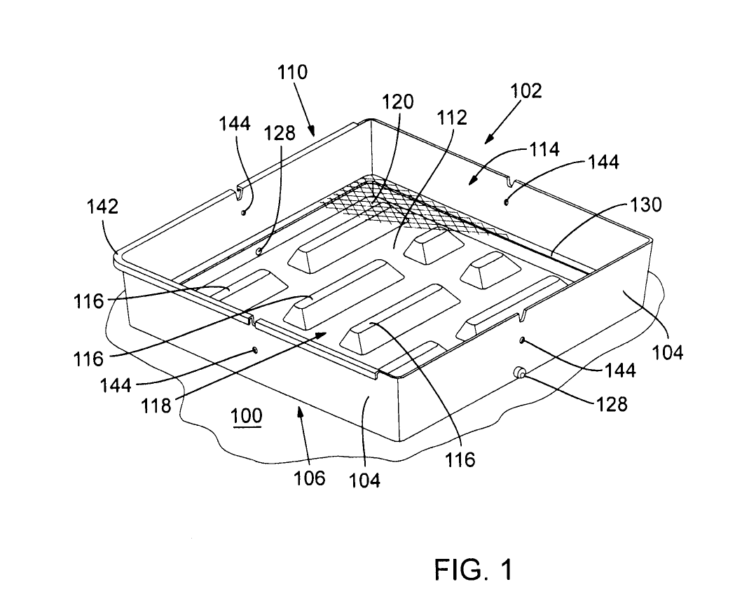

FIG. 1 shows a top perspective view of a rooftop 100 on which an embodiment of a water collection tray 102 for a vegetative roof system or a blue roof system is placed. Water collection tray 102 provides distributed rooftop detention or retention of water during and between rain showers to manage the controlled release of accumulated rainwater from a rooftop 100. Water collection tray 102 may act to detain or retain rainwater independent of other trays in the same roof system, or may be plumbed with other trays so that an array of trays may act together as a single water collection assembly.

Typically, vegetative roof designs provide little water flow control beyond the ability of the growing medium to detain water using capillary forces. As water saturates the growing medium, it is expected that water will overcome these forces and flow through the medium onto the roof surface. This process is especially pronounced in what are termed built-up systems, which are rolled out layers of vegetation growth materials. Other than the hydraulic properties of the growing medium, these layers typically have no ability to detain runoff. Tray systems exhibit some advantages over the built up systems. However, most tray systems are designed to drain water freely and would not be expected to substantially detain water within the tray. Put another way, like the built-up systems described above, water entering a typical tray system is expected to pass directly through the tray once the media within the tray becomes saturated with water. As an example, a tray system described by Carpenter et al. in U.S. Pat. No. 7,603,808 B2, provides small drainage holes that are directly exposed to the growth medium. In turn, the drainage holes may become occluded to varying extents, leading to an expectation of unpredictable drainage behavior and ability to satisfy specified drainage requirements during transient rainfall events. Further, because such drainage holes are fixed in size and number, such tray systems would be expected to be unable to vary drainage rates. Consequently, seasonal dry spells might harm vegetation in the trays.

Accordingly, some of the embodiments of water collection tray 102 described herein are configured to maintain separation between solid aggregate material, such as a soil or growing medium or a gravel ballast, from a water collection space within water collection tray 102. Further, some of the embodiments of water collection tray 102 may include a water flow regulator configured to adjust a rate at which water is drained away from the water collector.

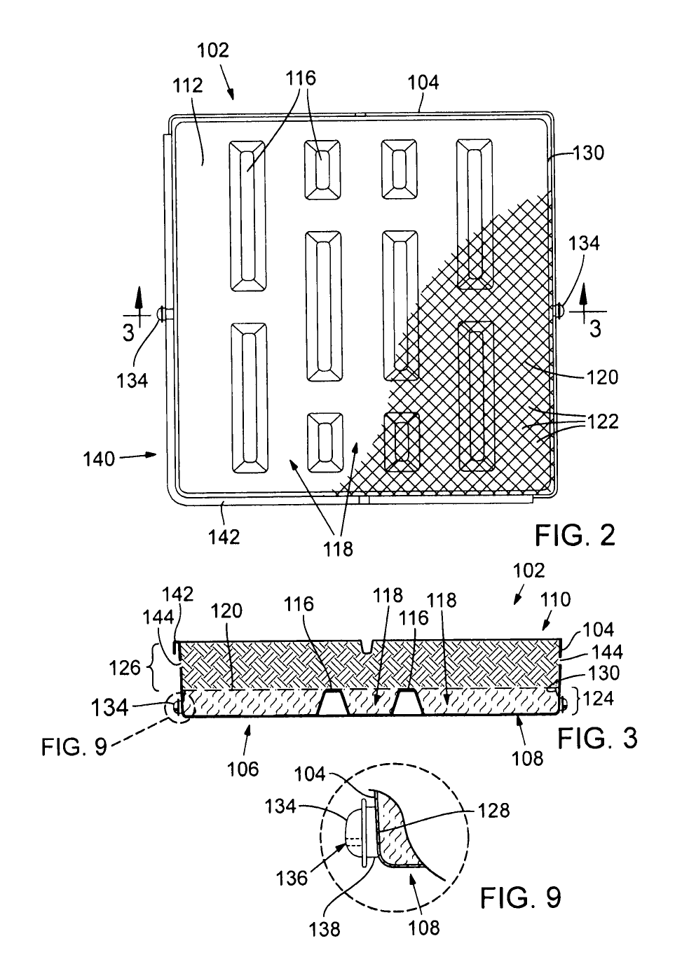

In the embodiment shown in FIG. 1 (also shown in a top plan view in FIG. 2 and in a side cross sectional view in FIG. 3), water collection tray 102 includes sidewalls 104 that define an overall depth of water collection tray 102, a bottom 106 having a bottom exterior surface 108 (FIG. 3) that rests on rooftop 100 when water collection tray 102 is in use. Embodiments of water collection tray 102 may be fabricated from a suitable plastic, metal, or other non-biodegradable material.

As shown in FIG. 1, water collection tray 102 has an open top 110, which, in combination with sidewalls 104 and a bottom interior surface 112, defines an interior region 114. In the embodiment shown in FIG. 1, bottom interior surface 112 includes multiple spaced apart ribs 116, and, between adjacent ones of the ribs, mutually spaced apart channels 118. If included, ribs 116 may be integrally formed into bottom 106 or bottom interior surface 112, or may be temporarily or permanently attached to bottom interior surface 112.

A water separation barrier 120 is positioned within interior region 114 between open top 110 and bottom interior surface 112 and above a water collector 124, shown in FIG. 2 as a shallow reservoir. Water separation barrier 120 has multiple openings 122 through which water admitted to water collection tray 102 enters a water collector 124.

In some embodiments, an aggregate material (shown in growing medium region 126 in FIG. 3), such as gravel or a soil mix or growing medium, may be placed above water separation barrier 120 to ballast the tray (e.g., in some blue roof systems) or to support plants growing out of open top 110. Rainwater falling onto the aggregate will percolate through the growing medium in growing medium region 126 until it reaches field moisture and flow becomes saturated. Thereafter, water will freely drain from the growing medium through openings 122 in water separation barrier 120. In such embodiments, water separation barrier 120 may permeable to both water and gas, but not permeable to aggregate materials such as sand, soil, or gravel, and in some embodiments may not be permeable to some vegetation materials (e.g., plant roots) to avoid clogging a drain 128, described in more detail below, opening out of water collector 124. In some embodiments, water separation barrier 120 may include a screen, but skilled persons will understand that suitable membranes, meshes, and perforated structures may also be employed.

In some embodiments, one or more raised barrier supports may brace an underside of water separation barrier 120. The embodiment shown in FIGS. 1, 2, and 3 includes ribs 116 positioned to provide sufficient support for the barrier and any anticipated load placed on top (e.g., growing medium and plant matter) while providing free space around the selected ribs for water to seep from the barrier above and to flow within water collector 124 to drain 128. The embodiment shown in FIGS. 1, 2, and 3 also includes a perimeter support 130 located on sidewalls 104 to provide edge support for water separation barrier 120. For example, a top surface of water separation barrier 120 may be placed beneath perimeter support 130 to prevent collapse of the barrier when aggregate material is placed on top of the barrier.

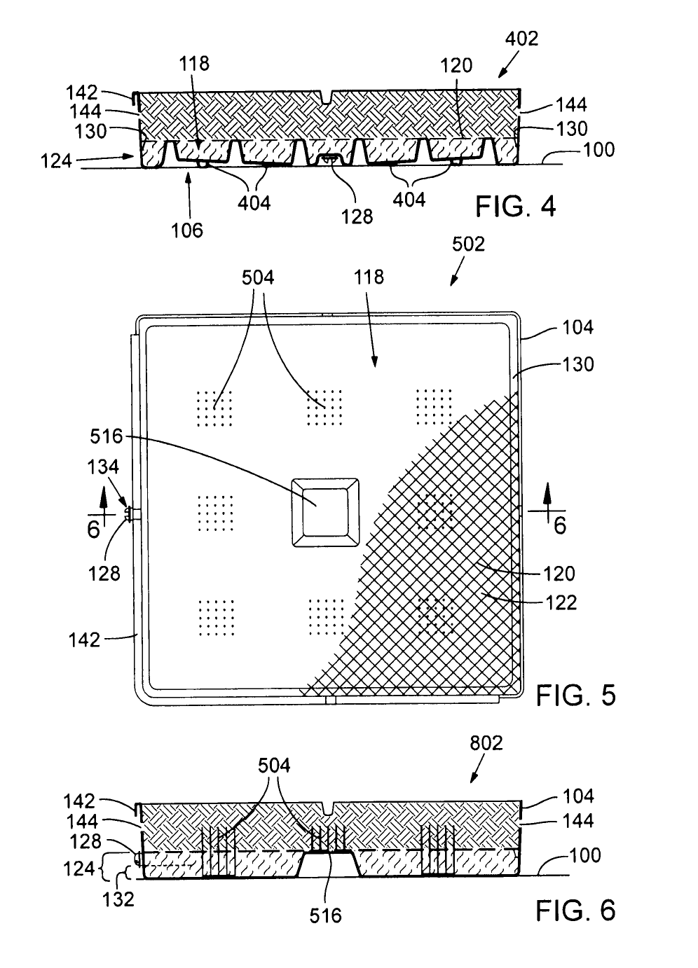

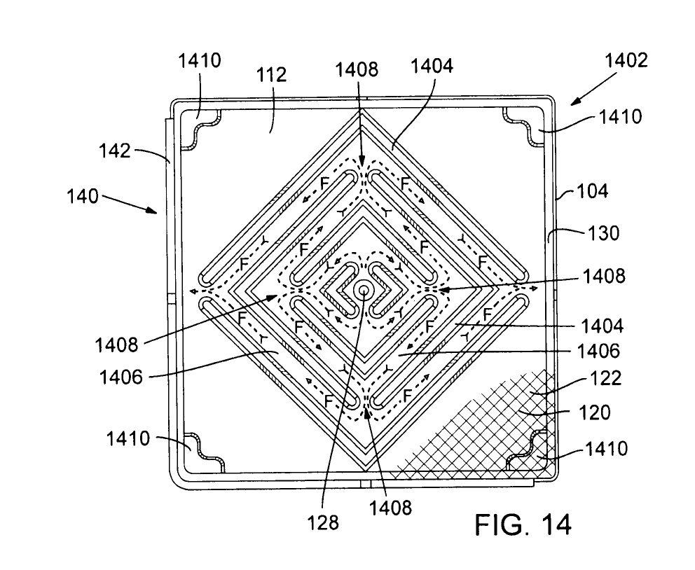

Water collector 124 receives water from openings 122 in water separation barrier 120. In some embodiments, water accumulates in water collector 124 until the water level reaches a drain 128 opening out of water collector 124. Thereafter, water flows out of water collector 124 through drain 128. In the embodiment shown in FIGS. 1, 2, and 3, drain 128 is located at an edge of bottom interior surface 112 that corresponds to a lowest position within water collector 124. Typically, the lowest position corresponds to an edge or a corner location. However, a skilled person will recognize that the position of the outlet may vary. FIG. 4 shows an embodiment of a water collection tray 402 where drain 128 is located approximately at a center of bottom 106. In some of such embodiments, the interior of water collector 124 may be shaped so that the center corresponds to a lowest point of the collector, even on roofs having slopes of up to 0.5 inch-per-foot (approximately 4.17 cm per meter), or up to a 4.2% slope. For example, bottom interior surface 112 may have an inverted conical or pyramidal shape. In the example shown in FIG. 4, tray supports 404 of different heights are positioned beneath channels 118 lift bottom exterior surface 108 off of rooftop 100, and, in combination with ribs 116, define the interior shape of water collector 124. Skilled persons will realize that other methods of supporting an underside of channels 118 in such embodiments may also be employed without departing from the scope of the present disclosure. Alternatively, in some embodiments having a centrally positioned drain 128, an interior surface of water collector 124 may not exhibit a sloping profile toward the drain. For example, FIG. 14 shows a side cross sectional view of an embodiment of a water collection tray 1302 having an essentially flat bottom interior surface 112.

In some embodiments, drain 128 may be positioned above the lowest point within water collector 124 to create a reservoir 132 (FIG. 6) of stored water. Such embodiments may be expected to permanently reduce the volume of stormwater runoff from the roof, and possibly reduce an amount of water used to irrigate plants that is supplied from external sources. Storing the collected water in reservoir 132 separately from the growing medium may avoid extended saturation of the growing medium, which can cause the growing medium to become anaerobic and unsuitable for plant growth. FIGS. 5 and 6 show top and side cross-section views, respectively, of an embodiment of a water collection tray 502 having a water separation barrier 120 elevated above water collector 124 by a centrally-positioned raised barrier support 516. Drain 128 is positioned above the lowest point in water collector 124 to form a reservoir 132 where water may be stored for later use. For example, the stored water may be used for additional water retention or made available for plant uptake during dry periods. In the embodiment shown in FIGS. 5 and 6, an optional water permeable wick 504 fluidly couples water collector 124 with growing medium region 126 to draw water from reservoir 132 into the growing medium above. In some examples, water permeable wick 504 may transfer water to growing medium 126 by pore pressure or capillary action.

In some embodiments, water collector 124 may include an absorbent medium compartment. For example, a phosphorus absorber such as a perlite-based medium sold under the trade name PhosphoSorb™, by Contech Engineered Solutions LLC, could be placed in the compartment. As water passes through the absorbent medium, a portion of phosphorus dissolved in the water may become bound to alumina sites in the absorbent medium.

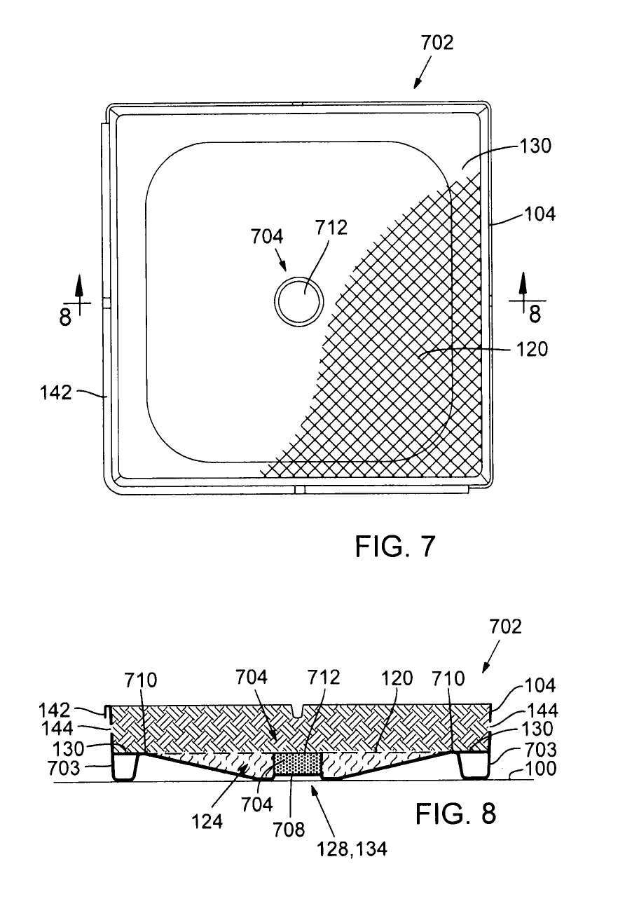

FIGS. 7 and 8 show top plan and cross-sectional views, respectively, of an embodiment of a water collection tray 702 supported on rooftop 100 using feet 703 positioned at opposite edges of the tray. Water collection tray 702 includes an absorbent medium compartment 704 in fluid communication with water collector 124. Absorbent medium compartment 704 is bounded by an absorbent medium-retaining wall 706 that is permeable to water but that is impermeable to an absorbent medium contained therein so that water may flow in and out of the compartment without loss of the medium. In some embodiments, absorbent medium compartment 704 may be positioned in fluid communication with drain 128, so that all of the water flowing through the drain also flows through the compartment. In the embodiment shown in FIG. 8, absorbent medium-retaining wall 706 is depicted as a vertical cylindrical screen positioned above drain 128. A compartment floor 708 of the embodiment of absorbent medium compartment 704 shown in FIG. 8 is also permeable to water but impermeable to the absorbent medium (e.g., a screen). In the embodiment shown in FIG. 8, a raised barrier support 710 braces an inner edge of perimeter support 130, which in turn supports water separation barrier 120 from below. Compartment top 712 supports an underside of a central region of water separation barrier 120. However, in the embodiment shown in FIGS. 7 and 8, compartment top 712 is impermeable to water so that water does not bypass water collector 124. Of course, skilled persons will appreciate that other configurations may be employed.

The flow of water exiting drain 128 is controlled by a water flow regulator 134. In some embodiments, water flow regulator 134 is positioned downstream of drain 128 so that all of the water flowing out of drain 128 passes through a water flow regulator 134. FIG. 9 shows an enlarged fragmentary view of an embodiment of water flow regulator 134 taken at location 9 in FIG. 3. In the embodiment shown in FIG. 9, water flow regulator 134 includes a restrictive orifice 136 positioned in a flow path downstream of drain 128. At steady-state, water will flow out of orifice 136 at a rate proportional to the diameter of the orifice, typically scaled by a coefficient of about 0.6 and proportional to the square root of the driving or pressure head above orifice 136. In some embodiments, the diameter of orifice 136 may be sized to allow for the filling of water collector 124 and the saturation of the growing medium during a design-basis rainfall event (e.g., during a rainfall event of a given intensity). Additionally or alternatively, in some embodiments, the orifice diameter may be selected, based in part on hydraulic or hydrologic calculations, to satisfy regulatory requirements or engineering practice guidelines for stormwater management, or both of them.

In the embodiment shown in FIG. 9, water flow regulator 134, including an orifice 136, is connected to a drain pipe 138 that receives water flowing out of drain 128. In the embodiment shown in FIG. 9, a centerline of orifice 136 is positioned below a centerline of drain pipe 138 to avoid retaining water behind water flow regulator 134. In the embodiment shown in FIG. 9, water flow regulator 134 disgorges water from drain pipe 138 to a location just above rooftop 100. Water flow regulator 134 may be made of any suitable material (e.g., plastic or metal) and may be located at any suitable position within drain pipe 138.

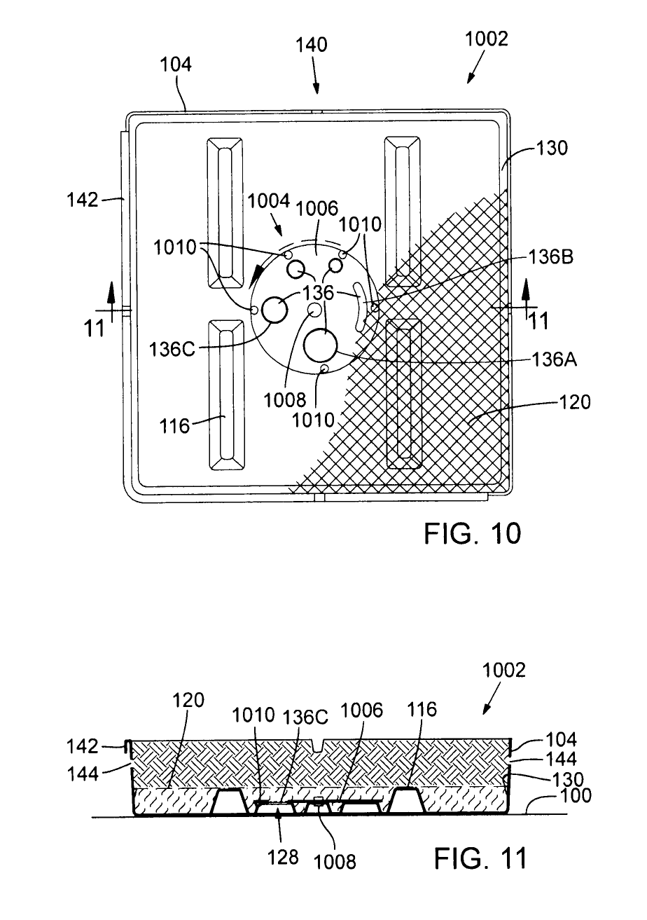

In some embodiments, the water flow regulator may be adjustable in use to permit user selection of orifice size upon or after installation of water collection tray 102 on a rooftop. FIGS. 10 and 11 schematically show top plan and cross-sectional views, respectively, of an embodiment of a water collection tray 1002 having an adjustable water flow regulator 1004 including a rotatable disk 1006 having multiple restriction orifices 136 of different sizes. Orifice sizes may be predefined based on seasonal or geographical rainfall patterns. For example, one orifice may be sized to detain a 10 year TYPE II rainfall distribution and reduce the peak flow to that associated with a 6-month storm. Other orifices 136 within rotatable disk 1006 may be sized to detain Types I, IA, and TYPE III rainfall patterns, while still other orifices may be sized to provide no restriction (shown at 136A) or a user-defined restriction (shown at 136B). In the embodiment shown in FIGS. 10 and 11, rotatable disk 1006 rotating about a central axle 1008 engages a detent mechanism 1010 at a perimeter region of rotatable disk 1006 to releasably lock a selected orifice (shown at 136C in FIG. 13) in a flow path of drain 128. Detent mechanism 1010 provides positive indication that an orifice is aligned with a flow path leading from drain 128 via one or both of audible or tactile feedback and may prevent inadvertent misalignment of adjustable water flow regulator 1004 at a later time.

In some embodiments, water flowing out of water flow regulator 134 may empty onto rooftop 100; while in other embodiments, water flowing out of water flow regulator 134 may be routed through a plumbing system. Regardless of whether water flowing out of water flow regulator 134 is added to the water falling on rooftop 100 during rainfall, in some settings, it may be desirable to retard water flow across the roof, as the delay may result in a decrease peak water flow off of the roof. To retard water flow across the surface of rooftop 100, in some embodiments, bottom exterior surface 108 may form a tortuous water flow pattern that impedes water flow. For example, water flowing across the roof in contact with bottom exterior surface 108 may cascade through gaps formed between channels 118.

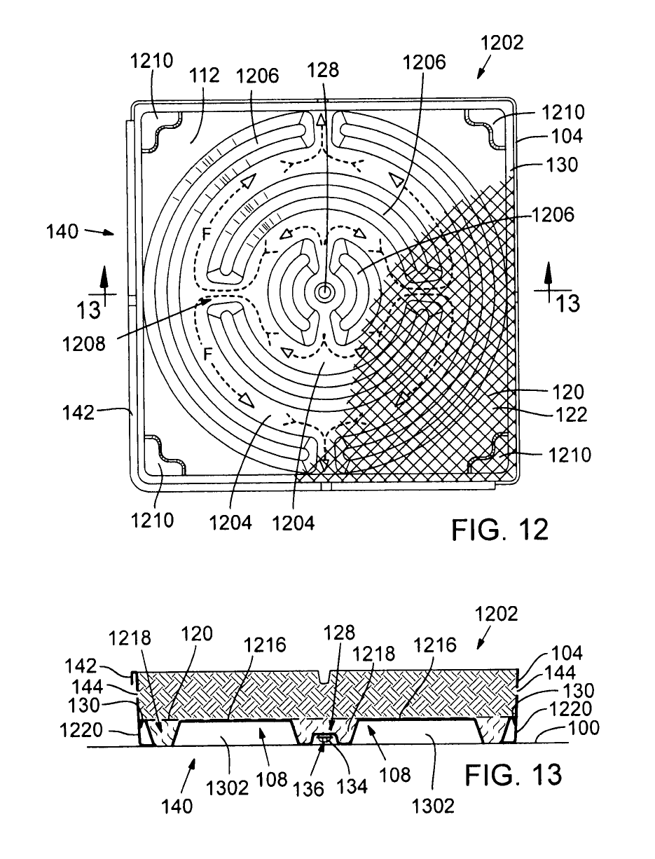

FIGS. 12 and 13 are top plan and cross-sectional views, respectively, of an embodiment of a water collection tray 1202, showing raised barrier supports 1204 and an array of concentrically arranged broken circular water channels 1206 formed in bottom interior surface 112. As shown in FIGS. 12 and 13, water exiting centrally-located drain 128 follows a branched flow path (marked by arrows labeled ‘F’), outwardly toward edges of tray 1202 flowing in spaces 1302 formed between rooftop 100 (FIG. 14) and bottom exterior surface 108 and defined by a symmetrically oriented bottom pattern 140 formed in bottom 106. Symmetrically oriented bottom pattern 140 is configured to detain water flow on the roof regardless of how bottom 106 is oriented when placed against rooftop 100. As water flows along a space formed underneath a raised barrier support 1204, gaps 1208 lead to junctions that divide the flow again and again as water flows toward a perimeter region of the tray. The embodiment of water collection tray 1202 shown in FIGS. 12 and 13 is supported by feet 1210 at corner edge locations and by the undersides of channels 1206, which rest against rooftop 100. Because the undersides of channels 1206 rest against rooftop 100, water flowing through gaps 1208 encounters is forcibly divided into branching paths, slowing the flow of water through spaces 1302. In some embodiments, low points within such trays near drain 128 may also detain water locally, potentially further slowing the rate of runoff from rooftop 100.

FIG. 14 is a top plan view of another embodiment of a water collection tray 1402 showing an array of concentrically arranged broken diamond water channels formed in bottom interior surface 112. In the embodiment shown in FIG. 14, angled channels 1404 and raised barrier supports 1406 are concentrically arranged around drain 128. Water exiting drain 128 flows outwardly toward a perimeter of the tray between bottom exterior surface 108 and rooftop 100. The water follows a branched flow path (marked by arrows labeled ‘F’) defined by a symmetrically oriented bottom pattern 140 formed in bottom 106. Bends in channels 1404 direct water flowing along rooftop 100 toward a series of gaps 1408 that allow water to flow from a central region of the tray toward the tray perimeter along a succession of diverging paths. Like the embodiment shown in FIGS. 12 and 13, the embodiment depicted in FIG. 14 rests on feet 1410 located at corner edge locations and contacts rooftop 100 at undersides of channels 1404.

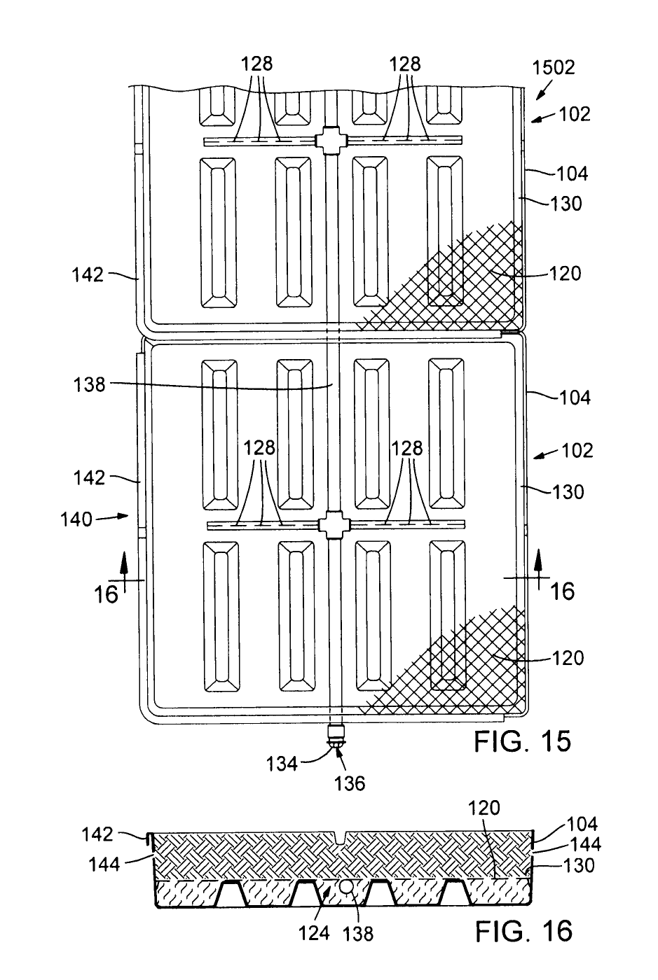

As introduced above, in some embodiments, water flowing out of water flow regulator 134 may be routed through a plumbing system. For example, several water collection trays 102 may be assembled in an array, and a single water flow regulator 134 may be used to adjust water flow for all of the water flowing out of the array. In some embodiments, water collection tray 102 may include coupling structures so that a group of trays may be configured as an interlocking system of trays. In the embodiment shown in FIGS. 1, 2, and 3, an L-shaped lip 142 formed on top of a pair of adjacent sidewalls 104 is configured to hook up and over a pair of complementary sidewalls 104 of a neighboring tray, so that the trays are secured to one another. FIGS. 1 and 3 also show connecting holes 144 included in sidewalls 104. When lip 142 of one tray overlaps a complementary sidewall 104 of an adjacent tray, a connecting hole 144 in adjacent sidewalls 104 of each tray are aligned. A joiner (not shown), such as a push fit rivet, may be placed through the complementary connecting holes 144 to lock, either releasably or permanently, the trays to one another. FIG. 15 shows a top plan view of an embodiment of an array 1502 of water collection trays 102. Drain pipe 138 forms a common flow path that joins drains 1504 in each tray with a single water flow regulator 134. FIG. 16 shows a side cross-sectional view of the embodiment shown in FIG. 15, showing the path of drain pipe 138 through water collector 124.

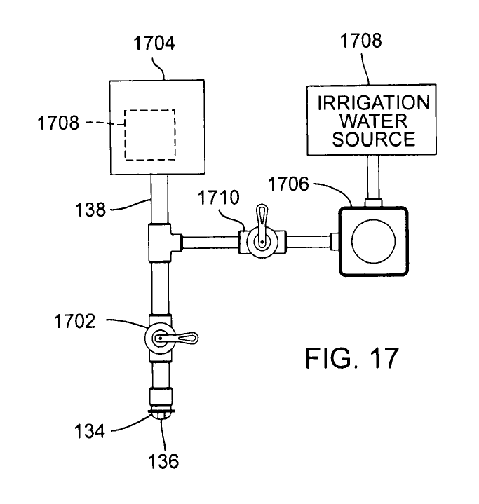

In some embodiments, drain pipe 138 may be used to supply irrigation water to water collectors 124 in the array. In one scenario, irrigation water may be fed to an array during dry periods. FIG. 17 schematically shows an embodiment of a water flow regulator isolation valve 1702 positioned to isolate water flow regulator 134 from array 1704. FIG. 17 also shows an irrigation valve 1706 connected to drain pipe 138 between array (shown schematically at 1704) and water flow regulator isolation valve 1702 so that irrigation water may be fed to array 1704 from an irrigation water source 1708. In some embodiments, irrigation water source 1708 may be connected with a source of reclaimed building water, harvested roof runoff, or plumbed to a municipal water supply. In use, water flow regulator isolation valve 1702 is closed by either manual or computer program operation when irrigation is desired. Opening irrigation valve 1706 causes irrigation water to flow into drain pipe 138, charging water collectors 128 or, in some embodiments, one or more irrigators (shown schematically at 1710) coupled with drain pipe 138. For example, water may be fed through drain pipe 138 to a pressure compensating drip irrigator, such as Model PC8050B sold by Raindrip, Inc. of Fresno, Calif.

While many of the examples described herein relate to vegetation roofs, where plants grow within a growing medium placed inside of water collection tray 102, skilled persons will understand that, in some embodiments, water collection trays 102 may be used in blue roof systems. Because many blue roofs simply retain or detain water atop a roof and include a water outlet at the low point of the roof, the roof slope often limits the amount of water that may be held in the system. Embodiments of water collection tray 102 employed in blue roof systems are expected to represent a vast improvement over other blue roofs because water retention by individual trays may improve weight distribution across the roof and permit use on more steeply sloped roofs. Further, during freezing conditions, expansion forces may be mitigated by the ability of individual trays in an array to move somewhat independently of one another.

When used in blue roof applications, water collection trays 102 may detain and retain water for release by drainage and evaporation, or in some settings, by evaporation alone. Accordingly, water collection tray 102 may include a suitable aggregate medium (e.g., gravel ballast) or may contain essentially only water. In some embodiments, water collection tray 102 may not include any aggregate material at all during use. For example, in some blue roof systems, water collection tray 102 may simply hold water for eventual release. In such systems, water separation barrier 120 may include a debris screen to prevent the introduction of trash or debris into water collector 124 or an insect barrier to prevent the growth of vectors (e.g., mosquitoes or other pests) within water collector 124.

It will be obvious to those having skill in the art that many changes may be made to the details of the above-described embodiments without departing from the underlying principles of the invention. The scope of the present invention should, therefore, be determined only by the following claims.

1. A water collection tray for a vegetative roof system or a blue roof system, the water collection tray comprising:
a tray having sidewalls, a bottom, and an open top that defines an interior region;
a water separation barrier located in the interior region between the bottom and the top, the water separation barrier having multiple openings through which water admitted to the tray enters a water collector;
a drain opening out of the tray from the water collector; and
a water flow regulator in fluid communication with the drain at a downstream location so that all of the water flowing out of the drain passes through the water flow regulator.

2. The water collection tray of claim 1, in which the bottom has a bottom interior surface, the bottom interior surface including multiple spaced apart ribs, and between adjacent ones of the ribs are formed mutually spaced apart channels into which water passing through the openings collects.

3. The water collection tray of claim 2, in which the bottom has a bottom exterior surface, and in which the channels and the ribs form, in the bottom exterior surface, a tortuous water flow pattern that impedes water flow in contact with the bottom exterior surface.

4. The water collection tray of claim 2, in which the ribs support the exclusion barrier.

5. The water collection tray of claim 1, further comprising a water permeable wick fluidly coupling the water collector with an aggregate medium space located between the water separation barrier and the open top to draw water from the water collector into the aggregate medium space.

6. The water collection tray of claim 1, in which the water flow regulator includes a flow control restriction.

7. The water collection tray of claim 6, in which the flow control restriction includes a flow restriction orifice.

8. The water collection tray of claim 1, in which the water flow regulator includes a rotatable disk having multiple flow restriction orifices of different sizes, and in which the rotatable disk engages with a detent mechanism to releasably lock a selected flow restriction orifice in a flow path of the drain.

9. The water collection tray of claim 1, further comprising:
another vegetation tray including another drain; and
a common flow path with which the drains are fluidly communicates and with which the water flow regulator fluid communicates so that all of the water flowing out of the drains passes through the water flow regulator.

10. The water collection tray of claim 1, further comprising:
a flow path in fluid communication with the drain and with the water flow regulator;
a water flow regulator isolation valve positioned between the water flow regulator and the drain to isolate the water flow regulator from the water collector; and
an irrigation valve in fluid communication with the flow path between the drain and the water flow regulator isolation valve to supply irrigation water from an irrigation water source to the water collector.

11. The water collection tray of claim 1, further comprising an absorbent medium compartment in fluid communication with the water collector, the absorbent medium compartment having an absorbent medium-retaining compartment wall that is permeable to water.

12. The water collection tray of claim 11, in which the absorbent medium compartment is in fluid communication with the drain, so that all of the water flowing through the drain also flows through the absorbent medium compartment.
